(19) United States
(12) Patent Application Publication
(10) Pub. No.: US 2025/0031617 A1
(43) Pub. Date: Jan. 30, 2025

(54) MONITORING SYSTEM FOR A CONVEYING SYSTEM OF AN AGRICULTURAL HARVESTER

(71) Applicant: CNH Industrial America LLC, New Holland, PA (US)

(72) Inventors: Jordan Beckhusen, McGregor, TX (US); Scott Simmons, Lititz, PA (US)

(21) Appl. No.: 18/784,172

(22) Filed: Jul. 25, 2024

Related U.S. Application Data
(60) Provisional application No. 63/515,422, filed on Jul. 25, 2023.

(51) Int. Cl. A01D 41/127; A01F 15/07

(52) U.S. Cl. CPC A01D 41/1274; A01F 15/071

(57) ABSTRACT

A monitoring system for a conveying system of an agricultural harvester includes a controller configured to receive a sensor signal indicative of a thickness of a mat of agricultural product formed by a pair of opposing belts. The controller is also configured to determine a volume of the mat based on the thickness, identify variations in the thickness of the mat along a translational direction of the mat, identify variations in the thickness of the mat along a lateral direction crosswise to the translational direction, or a combination thereof. Furthermore, the controller is configured to output an output signal based on the volume of the mat, the variations in the thickness of the mat along the translational direction, the variations in the thickness of the mat along the lateral direction, or the combination thereof.

### BACKGROUND

The present disclosure relates generally to a monitoring system for a conveying system of an agricultural harvester.

Agricultural harvesters are used to harvest agricultural products (e.g., cotton or other natural material(s)). For example, an agricultural harvester may include a header having drums configured to harvest the agricultural product from a field. The agricultural harvester may also include an air-assisted conveying system configured to move the agricultural product from the drums to an accumulator. The agricultural product may then be fed into a baler via a conveying system. The baler may compress the agricultural product into a package to facilitate storage, transport, and handling of the agricultural product. For example, a round baler may compress the agricultural product into a round bale within a baling chamber, such that the round bale has a desired size and density. After forming the bale, the bale may be wrapped with a bale wrap to secure the agricultural product within the bale and to generally maintain the shape of the bale.

### BRIEF DESCRIPTION

In certain embodiments, a monitoring system for a conveying system of an agricultural harvester includes a controller having a memory and a processor. The controller is configured to receive a sensor signal indicative of a thickness of a mat of agricultural product formed by a pair of opposing belts configured to compress the agricultural product and to transport the agricultural product from an accumulator of the agricultural harvester to a baler of the agricultural harvester. The controller is also configured to determine a volume of the mat based on the thickness, identify variations in the thickness of the mat along a translational direction of the mat, identify variations in the thickness of the mat along a lateral direction crosswise to the translational direction, or a combination thereof. Furthermore, the controller is configured to output an output signal based on the volume of the mat, the variations in the thickness of the mat along the translational direction, the variations in the thickness of the mat along the lateral direction, or the combination thereof.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a side view of an embodiment of an agricultural system having an agricultural product transport assembly;

FIG. 2 is a schematic view of an embodiment of an agricultural product transport assembly that may be employed within the agricultural system of FIG. 1;

FIG. 3 is a schematic view of an embodiment of a conveying system that may be employed within the agricultural product transport assembly of FIG. 2;

FIG. 4 is a schematic view of a portion of an embodiment of a monitoring system that may be employed within the conveying system of FIG. 3;

FIG. 5 is a schematic view of a portion of an embodiment of a monitoring system that may be employed within the conveying system of FIG. 3;

FIG. 6 is a schematic view of a portion of an embodiment of a monitoring system that may be employed within the conveying system of FIG. 3; and

FIG. 7 is a flow diagram of an embodiment of a method for monitoring a mat of agricultural product.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

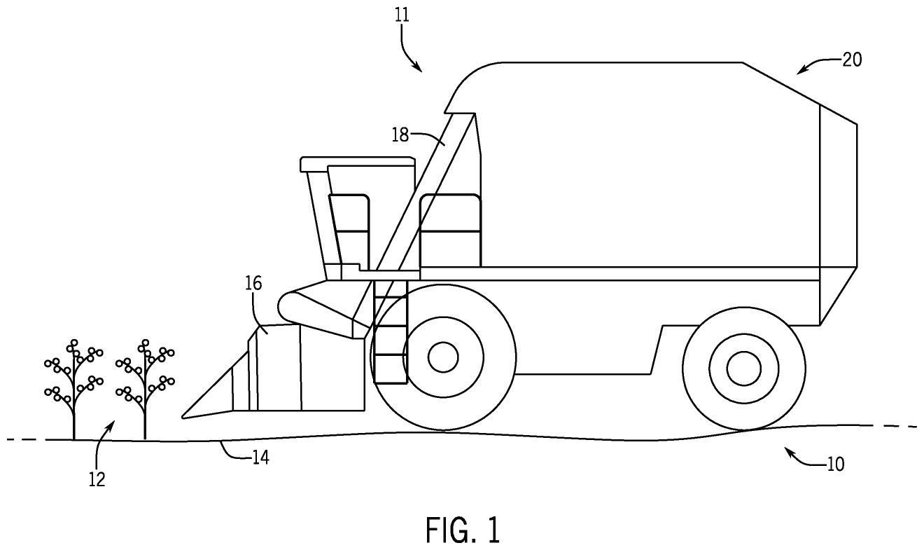

FIG. 1 is a side view of an embodiment of an agricultural system 10 (e.g., harvester, agricultural harvester) having an agricultural product transport assembly 11. The agricultural system 10 is configured to harvest agricultural product 12 (e.g., cotton) from a field 14 and to form the agricultural product 12 into bales (e.g., agricultural bales). In the illustrated embodiment, the agricultural system 10 includes a header 16 having drums configured to harvest the agricultural product 12 from the field 14. Additionally, the agricultural product transport assembly 11 of the agricultural system 10 includes an air-assisted conveying system 18 configured to move the agricultural product 12 from the drums of the header 16 to an accumulator of the agricultural product transport assembly 11. The agricultural product transport assembly 11 also includes a conveying system configured to convey the agricultural product 12 from the accumulator into a baler 20 (e.g., agricultural baler). The baler 20 is supported by and/or mounted within or on a chassis of the agricultural system 10. The baler 20 may form the agricultural product 12 into round bales. However, in other embodiments, the baler 20 of the agricultural system 10 may form the agricultural product into square bales, polygonal bales, or bales of other suitable shape(s). After forming the agricultural product 12 into a bale, a bale wrapping system of the agricultural system 10 wraps the bale with a bale wrap to secure the agricultural product 12 within the bale and to generally maintain a shape of the bale.

As discussed in detail below, the conveying system includes a pair of opposing belts configured to compress the agricultural product 12 and to transport the agricultural product 12 from the accumulator to the baler 20. Furthermore, in certain embodiments, the conveying system includes a monitoring system having a sensor configured to output a sensor signal indicative of a thickness of a mat of the agricultural product formed by the pair of opposing belts. The monitoring system also includes a controller having a memory and a processor, in which the controller is communicatively coupled to the sensor. The controller is configured to receive the sensor signal indicative of the thickness of the mat. In addition, the controller is configured to determine a volume of the mat based on the thickness, identify variations in the thickness of the mat along a translational direction of the mat, identify variations in the thickness of the mat along a lateral direction crosswise to the translational direction, or a combination thereof. The controller is also configured to output an output signal based on the volume of the mat, the variations in the thickness of the mat along the translational direction, the variations in the thickness of the mat along the lateral direction, or the combination thereof. For example, in certain embodiments, in response to determining the variations in the thickness of the mat along the translational direction exceed threshold variations, the controller may inform the operator via outputting the output signal to a user interface, and the operator may control operation of the conveying system to reduce the variations. Furthermore, in certain embodiments, in response to determining the variations in the thickness of the mat along the lateral direction exceed threshold variations, the controller may inform the operator via outputting the output signal to the user interface, and the operator may control operation of the conveying system to reduce the variations. Reducing the variations in the thickness of the mat enhances the uniformity of the agricultural product entering the baler. As a result, density variations within the resultant bale may be reduced, thereby enhancing downstream processing of the agricultural product.

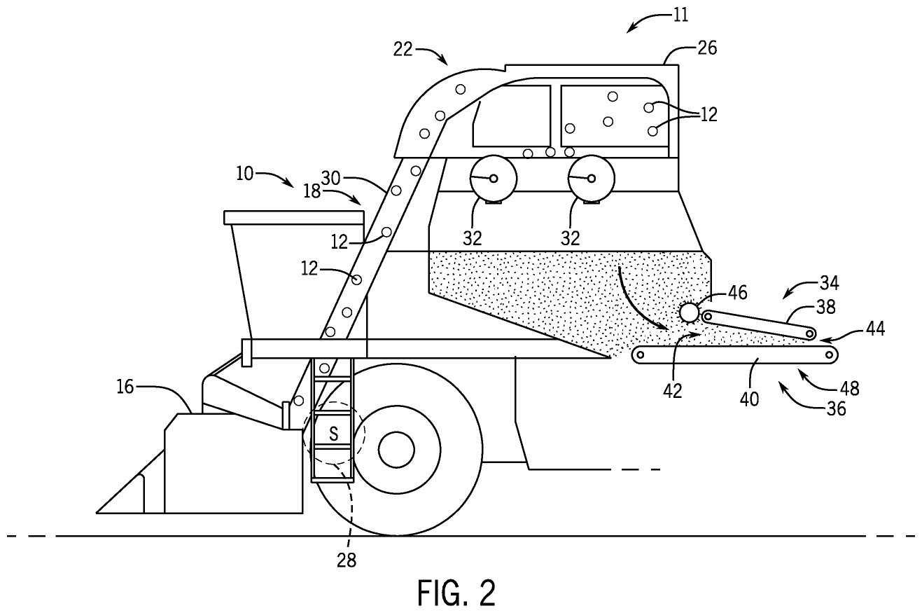

FIG. 2 is a schematic view of an embodiment of an agricultural product transport assembly 11 that may be employed within the agricultural system of FIG. 1. As previously discussed, the header 16 of the agricultural system 10 includes drums configured to harvest the agricultural product 12 (e.g., cotton) from the field. Furthermore, the air-assisted conveying system 18 is configured to move the agricultural product 12 from the drums of the header 16 to the accumulator 26. In the illustrated embodiment, the air-assisted conveying system 18 includes a conveying air source 28 configured to output a conveying air flow through one or more ducts 30. Each duct 30 receives the agricultural product 12 (e.g., cotton) from the header 16, and the conveying air flow output by the conveying air source 28 drives the agricultural product to move through the duct(s) 30 from the header 16 to the accumulator 26. In the illustrated embodiment, the agricultural product transport assembly 11 includes augers 32 configured to distribute the agricultural product 12 (e.g., cotton) laterally across the accumulator 26 (e.g., crosswise to the direction of movement of the agricultural product through the accumulator). In the illustrated embodiment, the agricultural product transport assembly 11 includes two augers 32. However, in other embodiments, the agricultural product transport assembly may include more or fewer augers (e.g., 0, 1, 3, 4, or more).

In the illustrated embodiment, the conveying system 34 of the agricultural product transport system 11 includes a pair of opposing belts 36 configured to compress the agricultural product 12 and to transport the agricultural product from the accumulator 26 to the baler. As illustrated, the pair of opposing belts 36 includes a first belt (e.g., top belt) 38 and a second belt (e.g., bottom belt) 40, in which the belts are positioned on opposite sides of the agricultural product 12. The agricultural product 12 enters the pair of opposing belts 36 at an inlet 42, and the agricultural product 12 exits the pair of opposing belts 36 at an outlet 44. Furthermore, in the illustrated embodiment, the conveying system 34 includes an agitation roller 46 positioned upstream of the inlet 42 of the pair of opposing belts 36. The agitation roller 46 is configured to agitate the agricultural product 12 entering the pair of opposing belts 36, thereby enhancing the uniformity of the distribution of the agricultural product passing through the pair of opposing belts 36.

As discussed in detail below, the conveying system 34 includes a monitoring system 48 having a sensor configured to output a sensor signal indicative of a thickness of a mat of the agricultural product 12 downstream from the inlet 42 of the pair of opposing belts 36. The monitoring system 48 also includes a controller having a memory and a processor, in which the controller is communicatively coupled to the sensor. The controller is configured to receive the sensor signal indicative of the thickness of the mat. In addition, the controller is configured to determine a volume of the mat based on the thickness, identify variations in the thickness of the mat along a translational direction of the mat, identify variations in the thickness of the mat along a lateral direction crosswise to the translational direction, or a combination thereof. The controller is also configured to output an output signal based on the volume of the mat, the variations in the thickness of the mat along the translational direction, the variations in the thickness of the mat along the lateral direction, or the combination thereof. For example, in certain embodiments, in response to determining the variations in the thickness of the mat along the translational direction exceed threshold variations, the controller may output the output signal indicative of instructions to control a speed of the agitation roller 46 and/or to control a speed of one belt relative to a speed of the other belt. Furthermore, in certain embodiments, in response to determining the variations in the thickness of the mat along the lateral direction exceed threshold variations, the controller may output the output signal indicative of instructions to control a speed of the agitation roller 46 and/or to control a speed of one belt relative to a speed of the other belt. Controlling a speed of the agitation roller 46 and/or a speed of one belt relative to a speed of the other belt may reduce the variations in the thickness of the mat, thereby enhancing the uniformity of the agricultural product 12 entering the baler. As a result, density variations within the resultant bale may be reduced, thereby enhancing downstream processing of the agricultural product.

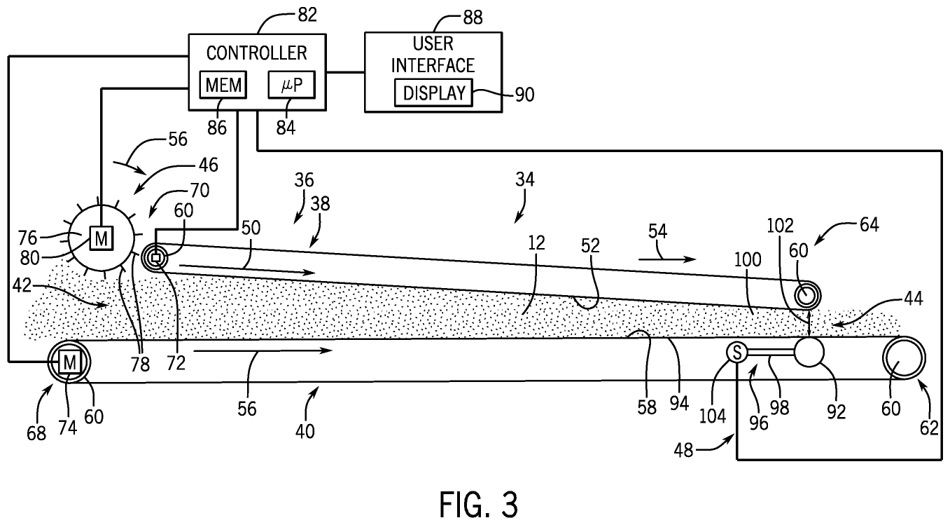

FIG. 3 is a schematic view of an embodiment of a conveying system 34 that may be employed within the agricultural product transport assembly of FIG. 2. As previously discussed, the pair of opposing belts 36 is configured to compress the agricultural product 12 and to transport the agricultural product from the accumulator to the baler. The first belt 38 is configured to rotate in a first rotational direction 50 to move an agricultural product engaging surface 52 of the first belt 38 toward the baler along a translational direction 54. Furthermore, the second belt 40 is positioned on an opposite side of the agricultural product 12 from the first belt 38, and the second belt 40 is configured to rotate in a second rotational direction 56, opposite the first rotational direction 50, to move an agricultural product engaging surface 58 of the second belt 40 toward the baler along the translational direction. Accordingly, the first belt 38 and the second belt 40 are configured to cooperate to move the agricultural product 12 from the accumulator to the baler along the translational direction 54. In the illustrated embodiment, the first belt 38 and the second belt 40 (e.g., the agricultural product engaging surface 52 of the first belt 38 and the agricultural product engaging surface 58 of the second belt 40) converge along the translational direction 54 toward the baler, thereby compressing the agricultural product 12 between the agricultural product engaging surfaces of the belts.

In the illustrated embodiment, each belt extends along an entire lateral extent of the conveying system (e.g., extent of the conveying system crosswise to the translational direction). However, in other embodiments, the conveying system may include multiple first belts distributed along the lateral extent of the conveying system, and/or the conveying system may include multiple second belts distributed along the lateral extent of the conveying system. Furthermore, in the illustrated embodiment, each belt is rotatably supported by two primary rollers 60, in which each primary roller 60 engages a first inner surface (e.g., top inner surface) and a second inner surface (e.g., bottom inner surface) of the respective belt. The primary rollers 60 are positioned at opposite ends of each belt with respect to the translational direction 54, and the primary rollers 60 extend along the entire lateral extent of the conveying system. In other embodiments, at least one belt may be supported by one or more additional primary rollers. For example, at least one belt may be supported by at least one additional primary roller positioned along the length of the belt with respect to the translational direction, and/or at least one belt may be supported by at least one additional primary roller positioned along a lateral extent of the belt (e.g., multiple primary rollers may be distributed along the lateral extent of the belt at a common position along the length of the belt with respect to the translational direction). In addition, at least one belt may be supported by one or more secondary rollers, in which each secondary roller only contacts one inner surface (e.g., the first inner surface or the second inner surface) of the belt.

While the belts converge along the translational direction 54 toward the baler in the illustrated embodiment, in other embodiments, the belts (e.g., the agricultural product engaging surfaces of the belts) may diverge or be parallel to one another along the translational direction toward the baler. Furthermore, while the conveying system 34 includes opposing belts positioned on opposite sides of the agricultural product 12 in the illustrated embodiment, in other embodiments, the conveying system may only include belt(s) positioned on one side of the agricultural product. For example, in certain embodiments, the conveying system may include belt(s) positioned on one side of the agricultural product and a bearing surface positioned on the opposite side of the agricultural product.

In the illustrated embodiment, the length of the second belt 40 with respect to the translational direction 54 is greater than the length of the first belt 38 with respect to the translational direction 54. As illustrated, a downstream end 62 of the second belt 40 extends beyond a downstream end 64 of the first belt 38 with respect to the translational direction 54. While the downstream end 62 of the second belt 40 extends beyond the downstream end 64 of the first belt 38 with respect to the translational direction 54 in the illustrated embodiment, in other embodiments, the downstream end of the first belt may extend beyond the downstream end of the second belt with respect to the translational direction, or the downstream ends of the belts may be located at the same position with respect to the translational direction. Furthermore, in the illustrated embodiment, an upstream end 68 of the second belt 40 is positioned upstream of an upstream end 70 of the first belt 38 with respect to the translational direction 54. As illustrated, the agitation roller 46 is positioned proximate to the upstream end 70 of the first belt 38, and the agitation roller 46 is positioned on the opposite side of the agricultural product 12 from the second belt 40. While the upstream end 68 of the second belt 40 is positioned upstream of the upstream end 70 of the first belt 38 with respect to the translational direction 54 in the illustrated embodiment, in other embodiments, the upstream end of the first belt may be positioned upstream of the upstream end of the second belt with respect to the translational direction, or the upstream ends of the belts may be located at the same position with respect to the translational direction. Furthermore, in certain embodiments, the length of the first belt may be equal to or greater than the length of the second belt. While the first belt 38 and the agitation roller 46 are positioned above the agricultural product 12 and the second belt 40 is positioned below the agricultural product 12 in the illustrated embodiment, in other embodiments, the first belt and the agitation roller may be positioned below the agricultural product, and the second belt may be positioned above the agricultural product. In addition, the inlet 42 of the pair of opposing belts 36 is positioned at the upstream end 70 of the first belt 38, and the outlet 44 of the pair of opposing belts 36 is positioned at the downstream end 64 of the first belt 38. However, in embodiments in which at least one belt has a different length, the inlet may be positioned at the upstream end of the belt having the farther-downstream upstream end, and the outlet may be positioned at the downstream end of the belt having the farther-upstream downstream end.

In the illustrated embodiment, the first belt 38 is driven to rotate by a motor 72 coupled to one primary roller 60. The motor 72 may include an electric motor, a pneumatic motor, a hydraulic motor, other suitable type(s) of motor(s), or a combination thereof. While the first belt 38 is driven to rotate by one motor 72 coupled to one primary roller 60 in the illustrated embodiment, in other embodiments, the first belt may be driven to rotate by multiple motors coupled to one or more primary rollers. Furthermore, in certain embodiments, the first belt may be driven to rotate by one or more motors coupled to one or more secondary rollers (e.g., alone or in combination with the motor(s) coupled to the primary roller(s)). In addition, in the illustrated embodiment, the second belt 40 is driven to rotate by a motor 74 coupled to one primary roller 60. The motor 74 may include an electric motor, a pneumatic motor, a hydraulic motor, other suitable type(s) of motor(s), or a combination thereof. While the second belt 40 is driven to rotate by one motor 74 coupled to one primary roller 60 in the illustrated embodiment, in other embodiments, the second belt may be driven to rotate by multiple motors coupled to one or more primary rollers. Furthermore, in certain embodiments, the second belt may be driven to rotate by one or more motors coupled to one or more secondary rollers (e.g., alone or in combination with the motor(s) coupled to the primary roller(s)).

In the illustrated embodiment, the agitation roller 46 is positioned upstream of the inlet 42 of the pair of opposing belts 36. The agitation roller 46 is configured to agitate the agricultural product 12 entering the pair of opposing belts 36, thereby enhancing the uniformity of the distribution of the agricultural product passing through the pair of opposing belts 36. In certain embodiments, the agitation roller 46 is configured to rotate in the second rotational direction 56. However, in other embodiments, the agitation roller may be configured to rotate in the first rotational direction. In the illustrated embodiment, the agitation roller 46 includes a roller 76 and multiple tines 78 extending outwardly from the roller 76. The tines 78 are configured to engage the agricultural product 12 as the agitation roller 46 rotates, thereby agitating the agricultural product 12. In the illustrated embodiment, the agitation roller 46 extends along the entire lateral extent of the conveying system (e.g., extent of the conveying system crosswise to the translational direction 54). However, in other embodiments, the conveying system may include multiple agitation rollers distributed along the lateral extent of the conveying system. Additionally or alternatively, the conveying system may include multiple agitation rollers distributed along the translational direction. Furthermore, while the conveying system 34 includes the agitation roller 46 in the illustrated embodiment, in other embodiments, the agitation roller may be omitted.

In the illustrated embodiment, the agitation roller 46 is driven to rotate by a motor 80 coupled to the roller 76. The motor 80 may include an electric motor, a pneumatic motor, a hydraulic motor, other suitable type(s) of motor(s), or a combination thereof. While the agitation roller 46 is driven to rotate by one motor 80 in the illustrated embodiment, in other embodiments, the agitation roller may be driven to rotate by multiple motors.

In the illustrated embodiment, the monitoring system 48 includes a controller 82 communicatively coupled to the motor 72 configured to drive the first belt 38 to rotate, the motor 74 configured to drive the second belt 40 to rotate, and the motor 80 configured to drive the agitation roller 46 to rotate. In certain embodiments, the controller 82 is an electronic controller having electrical circuitry configured to control the motors. In the illustrated embodiment, the controller 82 includes a processor, such as the illustrated microprocessor 84, and a memory device 86. The controller 82 may also include one or more storage devices and/or other suitable component(s). The processor 84 may be used to execute software, such as software for controlling the motors, and so forth. Moreover, the processor 84 may include multiple microprocessors, one or more “general-purpose” microprocessors, one or more special-purpose microprocessors, and/or one or more application specific integrated circuits (ASICs), or some combination thereof. For example, the processor 84 may include one or more reduced instruction set (RISC) processors.

The memory device 86 may include a volatile memory, such as random access memory (RAM), and/or a nonvolatile memory, such as read-only memory (ROM). The memory device 86 may store a variety of information and may be used for various purposes. For example, the memory device 86 may store processor-executable instructions (e.g., firmware or software) for the processor 84 to execute, such as instructions for controlling the motors, and so forth. The storage device(s) (e.g., nonvolatile storage) may include ROM, flash memory, a hard drive, or any other suitable optical, magnetic, or solid-state storage medium, or a combination thereof. The storage device(s) may store data, instructions (e.g., software or firmware for controlling the motors, etc.), and any other suitable data.

In the illustrated embodiment, the monitoring system 48 includes a user interface 88 communicatively coupled to the controller 82. The user interface 88 is configured to receive input from an operator and to provide information to the operator. The user interface 88 may include any suitable input device(s) for receiving input, such as a keyboard, a mouse, button(s), switch(es), knob(s), other suitable input device(s), or a combination thereof. In addition, the user interface 88 may include any suitable output device(s) for presenting information to the operator, such as speaker(s), indicator light(s), other suitable output device(s), or a combination thereof. In the illustrated embodiment, the user interface 88 includes a display 90 configured to present visual information to the operator. In certain embodiments, the display 90 may include a touchscreen interface configured to receive input from the operator.

In the illustrated embodiment, the conveying system 34 includes a sensing roller (e.g., roller) 92 engaged with an inner surface 94 of the second belt 40. As illustrated, the inner surface 94 is positioned on an opposite side of the second belt 40 from the agricultural product engaging surface 58. In addition, the sensing roller 92 is supported by a mounting assembly 96 that enables the sensing roller 92 to move in response to deflection of the second belt 40. For example, in the illustrated embodiment, the mounting assembly 96 includes pivot arms 98 pivotally coupled to opposite lateral ends of the sensing roller 92. The pivot arms 98 are also pivotally coupled to a frame/chassis of the agricultural system. Accordingly, the pivot arms 98 enable the sensing roller 92 to move toward the first belt 38 and away from the first belt 38. In addition, the mounting assembly 96 includes a biasing assembly configured to urge the sensing roller 92 toward the first belt 38. The biasing assembly may include any suitable biasing devices coupled to the pivot arms 98 and configured to urge the pivot arms 98 to move the sensing roller 92 toward the first belt 38. For example, the biasing devices may include coil spring(s), leaf spring(s), torsion spring(s), hydraulic cylinder(s), pneumatic cylinder(s), other suitable biasing device(s), or a combination thereof. While the mounting assembly 96 includes arms 98 in the illustrated embodiment, in other embodiments, the mounting assembly may include other suitable component(s) configured to movably couple the sensing roller to the frame/chassis, such as track assemblies, slider assemblies, pin and slot assemblies, etc.

In the illustrated embodiment, the sensing roller 92 is positioned at the outlet 44 of the pair of opposing belts 36. Accordingly, the sensing roller 92 is positioned at the same location as the primary roller 60 at the downstream end 64 of the first belt 38 with respect to the translational direction 54. Accordingly, the agricultural product 12 passes between the primary roller 60 at the downstream end 64 of the first belt 38 and the sensing roller 92 at the outlet 44 of the pair of opposing belts 36. A thickness of the mat 100 of the agricultural product 12 at the outlet 44 of the pair of opposing belts 36 may be determined based on a distance 102 between the primary roller 60 at the downstream end 64 of the first belt 38 and the sensing roller 92 (e.g., and based on the thickness of each belt).

In the illustrated embodiment, the monitoring system 48 includes a position sensor (e.g., sensor) 104 configured to monitor a position of the sensing roller 92 and to output a sensor signal indicative of the thickness of the mat 100. The position sensor 104 may monitor the position of the sensing roller 92 with respect to an axis extending through the pair of opposing belts 36 and through the mat 100 (e.g., vertical axis). For example, in the illustrated embodiment, the position sensor 104 may monitor the position of the sensing roller 92 relative to the primary roller 60 at the downstream end 64 of the first belt 38, thereby monitoring the distance 102 between the primary roller 60 at the downstream end 64 of the first belt 38 and the sensing roller 92. Accordingly, the sensor signal output by the position sensor 104 is indicative of the thickness of the mat 100 at the outlet 44 of the pair of opposing belts 36.

The position sensor 104 may include any suitable type(s) of sensing device(s). For example, in certain embodiments, the position sensor may include potentiometer(s) coupled to one or more arms 98 and configured to monitor rotation of the arm(s), thereby monitoring the position of the sensing roller 92. Furthermore, in certain embodiments, the position sensor 104 may include other suitable sensing device(s) (e.g., alone or in combination with the potentiometer(s)), such as one or more linear variable differential transformers, one or more linear potentiometers, one or more inductive sensors, one or more Hall effect sensors, one or more capacitive sensors, one or more ultrasonic sensors, one or more optical sensors, one or more other suitable type(s) of sensing device(s), or a combination thereof.

While the sensing roller 92 is positioned at the outlet 44 of the pair of opposing belts 36 in the illustrated embodiment, in other embodiments, the sensing roller may be positioned at another suitable location along the translational direction (e.g., between the inlet and the outlet of the pair of opposing belts, inclusive of the inlet and the outlet). For example, in certain embodiments, the sensing roller and a primary or secondary roller supporting the first belt may be positioned at the same location with respect to the translational direction. The position sensor may monitor the position of the sensing roller with respect to the axis extending through the pair of opposing belts and through the mat (e.g., vertical axis) at the location of the sensing roller. Accordingly, the position sensor may output the sensor signal indicative of the thickness of the mat at the location of the sensing roller. Furthermore, while the sensing roller 92 is engaged with the inner surface 94 of the second belt 40 in the illustrated embodiment, in other embodiments, the sensing roller may be engaged with an inner surface of the first belt. In such embodiments, the sensing roller may be positioned at any suitable location along the translational direction (e.g., between the inlet and the outlet of the pair of opposing belts, inclusive of the inlet and the outlet). For example, in certain embodiments, the sensing roller and a primary or secondary roller supporting the second belt may be positioned at the same location with respect to the translational direction. In addition, while the sensing roller 92 is a secondary roller in the illustrated embodiment, in other embodiments, the sensing roller may be a primary roller. While the conveying system 34 includes a single sensing roller in the illustrated embodiment, in other embodiments, the conveying system may include multiple sensing rollers, and the monitoring system may include corresponding position sensors to monitor the positions of the sensing rollers.

As illustrated, the position sensor 104 is communicatively coupled to the controller 82. The controller 82 is configured to receive the sensor signal indicative of the thickness of the mat 100 of the agricultural product 12 from the position sensor 104. Furthermore, in certain embodiments, the controller 82 is configured to determine a volume of the mat 100 based on the thickness. For example, the controller 82 may determine the volume of the mat 100 based on the thickness, the lateral extent of the pair of opposing belts 36 (e.g., extent of the pair of opposing belts crosswise to the translational direction), and a selected length. The selected length may be any suitable length, and a target selected length may be input by the operator via the user interface or stored on the controller (e.g., as a standard length). The controller may determine the selected length based on the speed of the pair of opposing belts, and the controller may determine the volume of the mat 100 in response to determining the selected length is within a threshold range of the target selected length.

Furthermore, the controller 82 is configured to output an output signal based on the volume of the mat 100. For example, the output signal may be indicative of instructions to control the user interface 88 to present a visual indication of the volume of the mat 100 (e.g., on the display 90). In addition, in certain embodiments, the output signal may be indicative of instructions to control one or more components of the agricultural system (e.g., alone or in combination with the instructions to the user interface). For example, in certain embodiments, the controller may output the output signal indicative of instructions to control the output of the air source of the air-assisted conveying system (e.g., to increase or decrease a flow rate of the agricultural product through the air-assisted conveying system), the speed of the pair of opposing belts (e.g., to increase or decrease the flow rate of the agricultural product to the baler), the speed of belt(s) of the baler (e.g., to increase or decrease the rate of formation of the bale), other suitable parameter(s), or a combination thereof, based on the volume of the mat 100. For example, the controller may output the output signal to the motor 72 configured to drive the first belt 38 to rotate and to the motor 74 configured to drive the second belt 40 to rotate. In response to determining the volume of the mat is less than a threshold volume, the controller may output the output signal indicative of instructions to increase the speed of the motors, thereby increasing the flow rate of the agricultural product toward the baler. Furthermore, in response to determining the volume of the mat is greater than a threshold volume, the controller may output the output signal indicative of instructions to decrease the speed of the motors, thereby decreasing the flow rate of the agricultural product toward the baler. Accordingly, the controller may control the output of the air source of the air-assisted conveying system, the speed of the pair of opposing belts, the speed of the belt(s) of the baler, other suitable parameter(s), or a combination thereof, based on the volume of the mat.

In certain embodiments, the controller 82 is configured to identify variations in the thickness of the mat 100 along the translational direction 54. For example, the thickness of the mat 100 may vary along the translational direction 54 due to variations in the distribution of agricultural product 12 as the agricultural product enters the inlet 42 of the pair of opposing belts 36. In certain embodiments, the controller 82 is configured to quantify the variations (e.g., using a statistical analysis technique, etc.). For example, the controller 82 may identify the variations by determining a mean variation magnitude, a median variation magnitude, a maximum variation magnitude, a minimum variation magnitude, a standard deviation of the variation magnitude, other suitable value(s), or a combination thereof, along a selected length of the mat 100 in the translational direction 54. Furthermore, in certain embodiments, the controller 82 may identify the variations by determining the number of times a difference between the thickness of the mat and an average thickness exceeds a threshold value along a selected length of the mat 100 in the translational direction 54. In certain embodiments, the controller 82 may identify the variations by determining a single numerical value (e.g., between 1 and 10) indicative of the degree of variations along a selected length of the mat 100 in the translational direction 54 (e.g., based on any one or more of the parameters determined above and/or other suitable parameter(s)).

Furthermore, the controller 82 is configured to output an output signal based on the variations in the thickness of the mat 100 along the translational direction 54. The output signal may be indicative of instructions to control the user interface 88 to present a visual indication of the variations in the thickness of the mat 100 along the translational direction 54 (e.g., on the display 90). For example, the controller 82 may output the output signal to the user interface 88 indicative of instructions to present any one or more of the parameters determined above, the single numerical value indicative of the degree of the variations, other suitable parameter(s), or a combination thereof. In response to receiving the indication from the user interface, the operator may control operation of the conveying system to reduce the variations. For example, in certain embodiments, in response to determining the variations in the thickness of the mat along the translational direction exceed threshold variations (e.g., the single numerical value is greater than a threshold value, the mean variation magnitude is greater than a threshold value, the median threshold magnitude is greater than a threshold value, etc.), the controller may inform the operator via outputting the output signal to the user interface, and the operator may control the conveying system to reduce the variations.

In addition, in certain embodiments, the output signal may be indicative of instructions to control one or more components of the agricultural system (e.g., alone or in combination with the instructions to the user interface) to reduce the variations in the thickness of the mat along the translational direction. For example, in certain embodiments, the controller 82 may output the output signal indicative of instructions to control a speed of one belt of the pair of opposing belts 36 relative to a speed of the other belt of the pair of opposing belts. The controller may output the output signal to the motor 72 configured to drive the first belt 38 to rotate and to the motor 74 configured to drive the second belt 40 to rotate. In response to determining the variations in the thickness of the mat 100 along the translational direction 54 exceed threshold variations (e.g., the single numerical value is greater than a threshold value, the mean variation magnitude is greater than a threshold value, the median threshold magnitude is greater than a threshold value, etc.), the controller 82 may output the output signal to at least one of the motors to control the speed of one belt relative to the speed of the other belt, thereby inducing turbulence within the agricultural product 12 of the mat 100. For example, during normal operation, the first belt 38 and the second belt 40 may be driven to rotate at the same speed to facilitate transport of the agricultural product from the accumulator to the baler. However, as the speed differential between belts increases, the turbulence of the agricultural product of the mat may increase. The turbulence may cause the variations in the thickness of the mat along the translational direction to be reduced, thereby enhancing the uniformity of the agricultural product entering the baler. Furthermore, in certain embodiments, the controller 82 may output the output signal indicative of instructions to control a speed of the agitation roller 46. For example, the controller may output the output signal to the motor 80 configured to drive the agitation roller 46 to rotate. In response to determining the variations in the thickness of the mat 100 along the translational direction 54 exceed threshold variations (e.g., the single numerical value is greater than a threshold value, the mean variation magnitude is greater than a threshold value, the median threshold magnitude is greater than a threshold value, etc.), the controller 82 may output the output signal to the motor 80 to increase the speed of the agitation roller 46, thereby increasing agitation of the agricultural product 12 entering the pair of opposing belts 36. The increased agitation may cause the variations in the thickness of the mat along the translational direction to be reduced, thereby enhancing the uniformity of the agricultural product entering the baler. Accordingly, the controller may control the speed of one belt relative to the other belt, the speed of the agitation roller, other suitable parameter(s) associated with one or more other components of the agricultural system, or a combination thereof, based on the variations in the thickness of the mat along the translational direction.

As previously discussed, the mounting assembly 96 includes pivot arms 98 pivotally coupled to opposite lateral ends of the sensing roller 92 and pivotally coupled to the frame/chassis of the agricultural system. In certain embodiments, the pivot arms 98 are fixedly coupled to one another, such that the pivot arms 98 rotate together. However, in certain embodiments, the pivot arms 98 may rotate independently of one another. In such embodiments, the sensing roller 92 may rotate about an axis extending along the translational direction 54 due to variations in the thickness of the mat 100 along a lateral direction crosswise to the translational direction 54. In addition, the position sensor 104 is configured to monitor an angle of the sensing roller 92 about the axis extending along the translational direction. For example, in certain embodiments, the position sensor may include a potentiometer coupled to each pivot arm 98 and configured to monitor rotation of the arms, thereby monitoring the position of the sensing roller 92 and the angle of the sensing roller 92. Furthermore, as previously discussed, the position sensor 104 may include other suitable sensing device(s) (e.g., alone or in combination with the potentiometers), such as one or more linear variable differential transformers, one or more linear potentiometers, one or more inductive sensors, one or more Hall effect sensors, one or more capacitive sensors, one or more ultrasonic sensors, one or more optical sensors, one or more other suitable type(s) of sensing device(s), or a combination thereof.

In certain embodiments, the controller 82 is configured to identify variations in the thickness of the mat 100 along the lateral direction crosswise to the translational direction 54. For example, the thickness of the mat 100 may vary along the lateral direction due to variations in the distribution of agricultural product 12 as the agricultural product enters the inlet 42 of the pair of opposing belts 36. In certain embodiments, the controller 82 is configured to quantify the lateral variations (e.g., using a statistical analysis technique, etc.). For example, the controller 82 may identify the lateral variations by determining a mean lateral variation magnitude, a median lateral variation magnitude, a maximum lateral variation magnitude, a minimum lateral variation magnitude, a standard deviation of the lateral variation magnitude, other suitable value(s), or a combination thereof, along a selected length of the mat 100 in the translational direction 54. Furthermore, in certain embodiments, the controller 82 may identify the lateral variations by determining the number of times a difference between a position of one lateral end of the sensing roller and a position of the other lateral end of the sensing roller exceeds a threshold value along a selected length of the mat 100 in the translational direction 54. In certain embodiments, the controller 82 may identify the lateral variations by determining a single numerical value (e.g., between 1 and 10) indicative of the degree of lateral variations along a selected length of the mat 100 in the translational direction 54 (e.g., based on any one or more of the parameters determined above and/or other suitable parameter(s)).

Furthermore, the controller 82 is configured to output an output signal based on the variations in the thickness of the mat 100 along the lateral direction. The output signal may be indicative of instructions to control the user interface 88 to present a visual indication of the variations in the thickness of the mat 100 along the lateral direction (e.g., on the display 90). For example, the controller 82 may output the output signal to the user interface 88 indicative of instructions to present any one or more of the parameters determined above, the single numerical value indicative of the degree of the variations, other suitable parameter(s), or a combination thereof. In response to receiving the indication from the user interface, the operator may control operation of the conveying system to reduce the variations. For example, in certain embodiments, in response to determining the variations in the thickness of the mat along the lateral direction exceed threshold variations (e.g., the single numerical value is greater than a threshold value, the mean variation magnitude is greater than a threshold value, the median threshold magnitude is greater than a threshold value, etc.), the controller may inform the operator via outputting the output signal to the user interface, and the operator may control the conveying system to reduce the variations.

In addition, in certain embodiments, the output signal may be indicative of instructions to control one or more components of the agricultural system (e.g., alone or in combination with the instructions to the user interface) to reduce the variations in the thickness of the mat along the lateral direction. For example, in certain embodiments, the controller 82 may output the output signal indicative of instructions to control a speed of one belt of the pair of opposing belts 36 relative to a speed of the other belt of the pair of opposing belts. The controller may output the output signal to the motor 72 configured to drive the first belt 38 to rotate and to the motor 74 configured to drive the second belt 40 to rotate. In response to determining the variations in the thickness of the mat 100 along the lateral direction exceed the threshold variations (e.g., the single numerical value is greater than a threshold value, the mean variation magnitude is greater than a threshold value, the median threshold magnitude is greater than a threshold value, etc.), the controller 82 may output the output signal to at least one of the motors to control the speed of one belt relative to the speed of the other belt, thereby inducing turbulence within the agricultural product 12 of the mat 100. For example, during normal operation, the first belt 38 and the second belt 40 may be driven to rotate at the same speed to facilitate transport of the agricultural product from the accumulator to the baler. However, as the speed differential between belts increases, the turbulence of the agricultural product of the mat may increase. The turbulence may cause the variations in the thickness of the mat along the lateral direction to be reduced, thereby enhancing the uniformity of the agricultural product entering the baler. Furthermore, in certain embodiments, the controller 82 may output the output signal indicative of instructions to control a speed of the agitation roller 46. For example, the controller may output the output signal to the motor 80 configured to drive the agitation roller 46 to rotate. In response to determining the variations in the thickness of the mat 100 along the lateral direction exceed threshold variations (e.g., the single numerical value is greater than a threshold value, the mean variation magnitude is greater than a threshold value, the median threshold magnitude is greater than a threshold value, etc.), the controller 82 may output the output signal to the motor 80 to increase the speed of the agitation roller, thereby increasing agitation of the agricultural product 12 entering the pair of opposing belts 36. The increased agitation may cause the variations in the thickness of the mat along the lateral direction to be reduced, thereby enhancing the uniformity of the agricultural product entering the baler. Accordingly, the controller may control the speed of one belt relative to the other belt, the speed of the agitation roller, other suitable parameter(s) associated with one or more other components of the agricultural system, or a combination thereof, based on the variations in the thickness of the mat along the lateral direction.

The controller may determine the volume of the mat based on the thickness, identify variations in the thickness of the mat along the translational direction, identify variations in the thickness of the mat along the lateral direction, or a combination thereof. In addition, the controller may output the output signal based on the volume of the mat, the variations in the thickness of the mat along the translational direction, the variations in the thickness of the mat along the lateral direction, or the combination thereof. Furthermore, in certain embodiments, the controller may determine/identify other suitable property/properties of the mat and output the output signal based on the respective determined/identified property/properties.

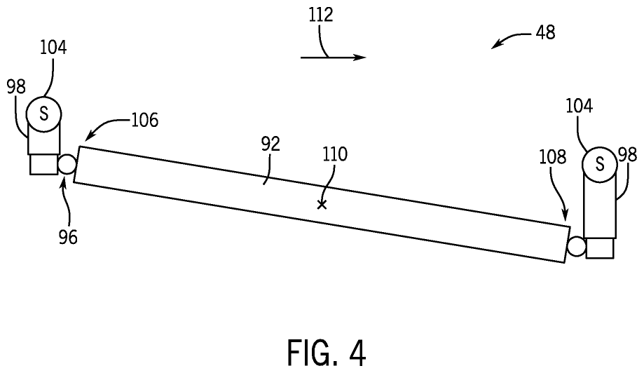

FIG. 4 is a schematic view of a portion of an embodiment of a monitoring system 48 that may be employed within the conveying system of FIG. 3. As previously discussed, the mounting assembly 96 includes pivot arms 98 pivotally coupled to opposite lateral ends of the sensing roller 92 and pivotally coupled to the frame/chassis of the agricultural system. As illustrated, one pivot arm 98 is pivotally coupled to a first lateral end 106 of the sensing roller 92, and the other pivot arm 98 is pivotally coupled to a second lateral end 108 of the sensing roller 92. In the illustrated embodiment, the pivot arms 98 may rotate independently of one another. Accordingly, the sensing roller 92 may rotate about an axis 110 extending along the translational direction due to variations in the thickness of the mat along a lateral direction 112 crosswise to the translational direction. In addition, the position sensor 104 is configured to monitor an angle of the sensing roller 92 about the axis 110 extending along the translational direction. For example, in certain embodiments, the position sensor may include a potentiometer coupled to each pivot arm 98 and configured to monitor rotation of the arms, thereby monitoring the position of the sensing roller 92 and the angle of the sensing roller 92. Furthermore, as previously discussed, the position sensor 104 may include other suitable sensing device(s) (e.g., alone or in combination with the potentiometers), such as one or more linear variable differential transformers, one or more linear potentiometers, one or more inductive sensors, one or more Hall effect sensors, one or more capacitive sensors, one or more ultrasonic sensors, one or more optical sensors, one or more other suitable type(s) of sensing device(s), or a combination thereof.

While the pivot arms 98 are configured to rotate independently of one another in the illustrated embodiment, in other embodiments, the pivot arms may be fixedly coupled to one another, such that the pivot arms rotate together. In such embodiments, the position sensor may monitor the position of the sensing roller without monitoring the angle of the sensing roller. Furthermore, in certain embodiments, the conveying system may include multiple sensing rollers distributed along the lateral direction. In such embodiments, a position sensor may be configured to monitor the position of each sensing roller, thereby enabling the controller to identify variations in the thickness of the mat along the lateral direction.

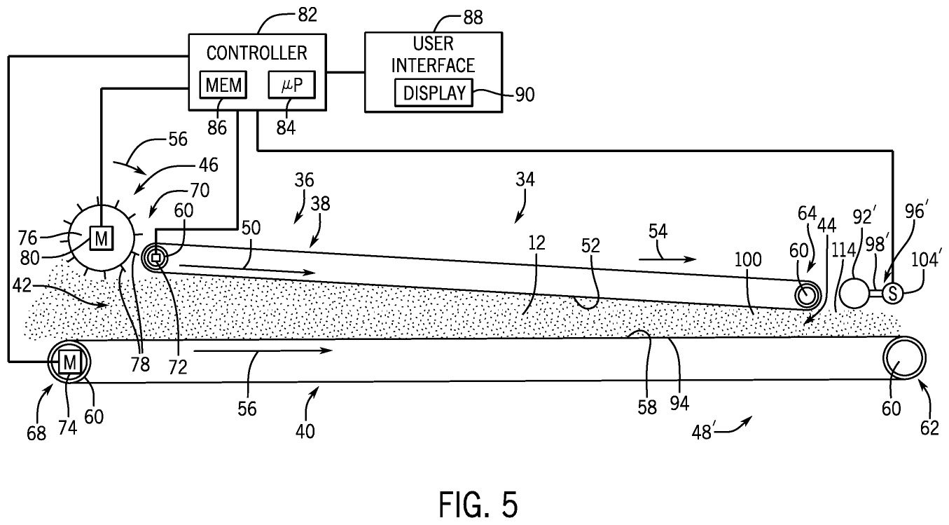

FIG. 5 is a schematic view of a portion of an embodiment of a monitoring system 48′ that may be employed within the conveying system of FIG. 3. In the illustrated embodiment, the conveying system includes a sensing roller (e.g., roller) 92′ positioned downstream from the outlet 44 of the pair of opposing belts 36 and configured to engage a surface 114 of the mat 100. In addition, the sensing roller 92′ is supported by a mounting assembly 96′ that enables the sensing roller 92′ to move in response to variations in the thickness of the mat 100. For example, in the illustrated embodiment, the mounting assembly 96′ includes pivot arms 98′ pivotally coupled to opposite lateral ends of the sensing roller 92′. The pivot arms 98′ are also pivotally coupled to the frame/chassis of the agricultural system. Accordingly, the pivot arms 98′ enable the sensing roller 92′ to move in response to variations in the thickness of the mat 100. In addition, the mounting assembly 96′ includes a biasing assembly configured to urge the sensing roller 92′ toward the surface 114 of the mat 100. The biasing assembly may include any suitable biasing devices coupled to the pivot arms 98′ and configured to urge the pivot arms 98′ to move the sensing roller 92′ toward the surface 114 of the mat 100. For example, the biasing devices may include coil spring(s), leaf spring(s), torsion spring(s), hydraulic cylinder(s), pneumatic cylinder(s), other suitable biasing device(s), or a combination thereof. While the mounting assembly 96′ includes arms 98′ in the illustrated embodiment, in other embodiments, the mounting assembly may include other suitable component(s) configured to movably couple the sensing roller to the frame/chassis, such as track assemblies, slider assemblies, pin and slot assemblies, etc.

In the illustrated embodiment, the monitoring system 48′ includes a position sensor (e.g., sensor) 104′ configured to monitor a position of the sensing roller 92′ and to output a sensor signal indicative of the thickness of the mat 100. The position sensor 104′ may monitor the position of the sensing roller 92′ with respect to an axis extending through the pair of opposing belts 36 and through the mat 100 (e.g., vertical axis). For example, in the illustrated embodiment, the position sensor 104′ may monitor the position of the sensing roller 92′ relative to the agricultural product engaging surface 58 of the second belt 40 downstream from the outlet 44 of the pair of opposing belts 36, thereby monitoring the thickness of the mat 100. Accordingly, the sensor signal output by the position sensor 104′ is indicative of the thickness of the mat 100 downstream from the outlet 44 of the pair of opposing belts 36.

The position sensor 104′ may include any suitable type(s) of sensing device(s). For example, in certain embodiments, the position sensor may include potentiometer(s) coupled to one or more arms 98′ and configured to monitor rotation of the arm(s), thereby monitoring the position of the sensing roller 92′. Furthermore, in certain embodiments, the position sensor 104′ may include other suitable sensing device(s) (e.g., alone or in combination with the potentiometer(s)), such as one or more linear variable differential transformers, one or more linear potentiometers, one or more inductive sensors, one or more Hall effect sensors, one or more capacitive sensors, one or more ultrasonic sensors, one or more optical sensors, one or more other suitable type(s) of sensing device(s), or a combination thereof.

While the sensing roller 92′ is positioned on the opposite side of the mat 100 from the second belt 40 in the illustrated embodiment, in other embodiments (e.g., in embodiments in which the downstream end of the first belt extends beyond the downstream end of the second belt along the translational direction), the sensing roller may be positioned on the opposite side of the mat from the first belt. Furthermore, while the conveying system 34 includes a single sensing roller 92′ in the illustrated embodiment, in other embodiments, the conveying system may include multiple sensing rollers, and the monitoring system may include corresponding position sensors to monitor the positions of the sensing rollers. In addition, the position sensor 104′ is communicatively coupled to the controller 82. The controller 82 is configured to receive the sensor signal indicative of the thickness of the mat 100 of the agricultural product 12 from the position sensor 104′.

As previously discussed, the mounting assembly 96′ includes pivot arms 98′ pivotally coupled to opposite lateral ends of the sensing roller 92′ and pivotally coupled to the frame/chassis of the agricultural system. In the illustrated embodiment, the pivot arms 98′ may rotate independently of one another. Accordingly, the sensing roller 92 may rotate about an axis extending along the translational direction due to variations in the thickness of the mat along a lateral direction crosswise to the translational direction 54. In addition, the position sensor 104′ is configured to monitor an angle of the sensing roller 92′ about the axis extending along the translational direction 54. For example, in certain embodiments, the position sensor may include a potentiometer coupled to each pivot arm 98′ and configured to monitor rotation of the pivot arms, thereby monitoring the position of the sensing roller 92′ and the angle of the sensing roller 92′. Furthermore, as previously discussed, the position sensor 104 may include other suitable sensing device(s) (e.g., alone or in combination with the potentiometers), such as one or more linear variable differential transformers, one or more linear potentiometers, one or more inductive sensors, one or more Hall effect sensors, one or more capacitive sensors, one or more ultrasonic sensors, one or more optical sensors, one or more other suitable type(s) of sensing device(s), or a combination thereof.

While the pivot arms 98′ are configured to rotate independently of one another in the illustrated embodiment, in other embodiments, the pivot arms may be fixedly coupled to one another, such that the pivot arms rotate together. In such embodiments, the position sensor may monitor the position of the sensing roller without monitoring the angle of the sensing roller. Furthermore, in certain embodiments, the conveying system may include multiple sensing rollers distributed along the lateral direction. In such embodiments, a position sensor may be configured to monitor the position of each sensing roller, thereby enabling the controller to identify variations in the thickness of the mat along the lateral direction.

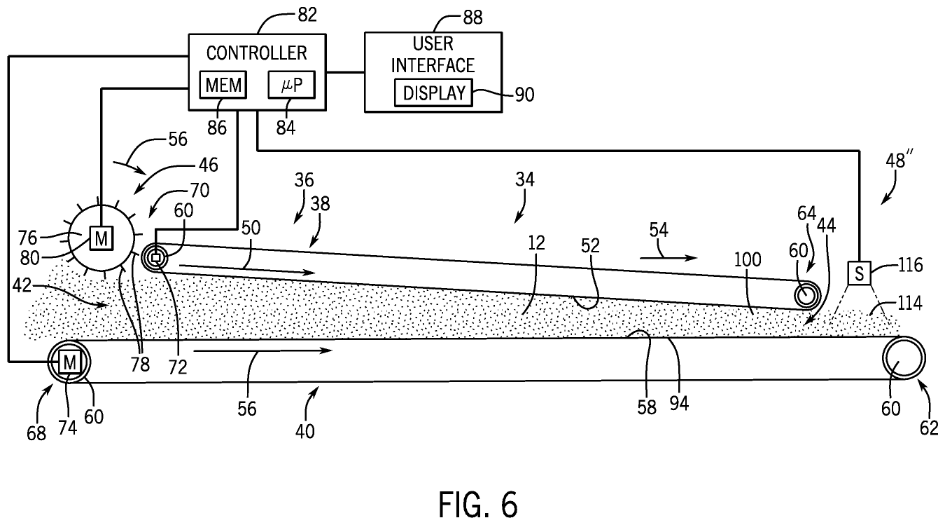

FIG. 6 is a schematic view of a portion of an embodiment of a monitoring system 48″ that may be employed within the conveying system of FIG. 3. In the illustrated embodiment, the monitoring system 48″ includes a non-contact sensor (e.g., sensor) 116 directed toward the surface 114 of the mat 100 downstream from the outlet 44 of the pair of opposing belts 36. The non-contact sensor 116 is configured to monitor the surface 114 of the mat 100 and to output the sensor signal indicative of the thickness of the mat 100. The non-contact sensor may include any suitable type(s) of sensing device(s), such as LIDAR sensor(s), RADAR sensor(s), optical sensor(s), other suitable type(s) of sensor(s), or a combination thereof. For example, in certain embodiments, the non-contact sensor 116 may monitor the surface 114 of the mat 100 in two dimensions (e.g., along the translational direction 54 and along the lateral direction). Furthermore, in certain embodiments, the non-contact sensor 116 may monitor the surface 114 of the mat in one dimension (e.g., only along the translational direction 54 or only along the lateral direction).

While the non-contact sensor 116 is positioned on the opposite side of the mat 100 from the second belt 40 in the illustrated embodiment, in other embodiments (e.g., in embodiments in which the downstream end of the first belt extends beyond the downstream end of the second belt along the translational direction), the non-contact sensor may be positioned on the opposite side of the mat from the first belt. Furthermore, while the monitoring system 48″ includes a single non-contact sensor 116 in the illustrated embodiment, in other embodiments, the monitoring system may include multiple non-contact sensors. In addition, the non-contact sensor 116 is communicatively coupled to the controller 82. The controller 82 is configured to receive the sensor signal indicative of the thickness of the mat 100 of the agricultural product 12 from the non-contact sensor 116. In certain embodiments, the monitoring system may include a single sensor (e.g., the position sensor disclosed above with reference to FIGS. 3-4, the position sensor disclosed above with reference to FIG. 5, or the non-contact sensor disclosed above with reference to FIG. 6). However, in other embodiments, the monitoring system may include a combination of the sensors disclosed above. In addition, in certain embodiments, the monitoring system may include other suitable sensor(s) (e.g., alone or in combination with one or more of the sensors disclosed above).

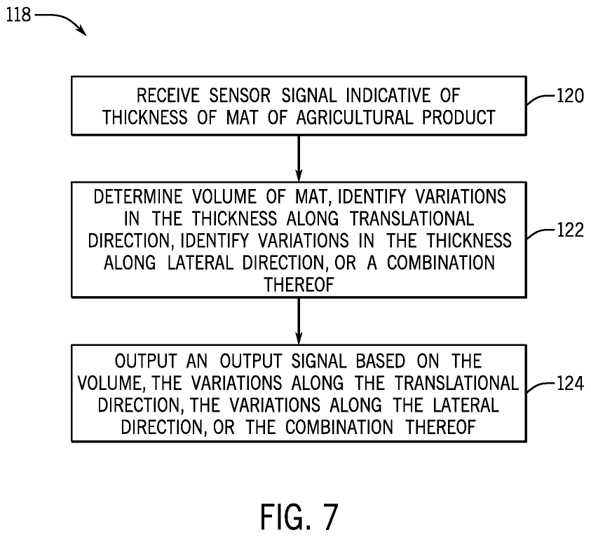

FIG. 7 is a flow diagram of an embodiment of a method 118 for monitoring a mat of agricultural product. The method 118 may be performed by the controller disclosed above with reference to FIGS. 3-6 or any other suitable controller(s). Furthermore, the steps of the method 118 may be performed in the order disclosed herein or in any other suitable order. For example, certain steps of the method may be performed concurrently. In addition, in certain embodiments, at least one of the steps of the method 118 may be omitted.

In the illustrated embodiment, the method 118 includes receiving a sensor signal indicative of the thickness of the mat of agricultural product, as represented by block 120. As previously discussed, in certain embodiments, the sensor signal may be received from a non-contact sensor directed toward a surface of the mat downstream from the outlet of the pair of opposing belts. Furthermore, in certain embodiments, the sensor signal may be received from a position sensor configured to monitor the position of the sensing roller engaged with one belt of the pair of opposing belts. In addition, in certain embodiments, the sensor signal may be received from a position sensor configured to monitor the position of a roller positioned downstream from the outlet of the pair of opposing belts and configured to engage a surface of the mat.

Furthermore, the method 118 includes determining the volume of the mat based on the thickness, identifying variations in the thickness of the mat along the translational direction, identifying variations in the thickness of the mat along the lateral direction crosswise to the translational direction, or a combination thereof, as represented by block 122. For example, as previously discussed, the volume of the mat may be determined based on the thickness, the lateral extent of the pair of opposing belts, and a selected length. Furthermore, as previously discussed, variations in the thickness of the mat along the translational direction may be identified by determining a mean variation magnitude, a median variation magnitude, a maximum variation magnitude, a minimum variation magnitude, a standard deviation of the variation magnitude, other suitable value(s), or a combination thereof, along a selected length of the mat in the translational direction. In addition, as previously discussed, lateral variations in the thickness of the mat may be identified by determining a mean lateral variation magnitude, a median lateral variation magnitude, a maximum lateral variation magnitude, a minimum lateral variation magnitude, a standard deviation of the lateral variation magnitude, other suitable value(s), or a combination thereof, along a selected length of the mat in the translational direction.

In addition, the method 118 includes outputting an output signal based on the volume of the mat, the variations in the thickness of the mat along the translational direction, the variations in the thickness of the mat along the lateral direction, or the combination thereof, as represented by block 124. For example, as previously discussed, the output signal may be indicative of instructions to control the user interface to present a visual indication of the volume of the mat, a visual indication of the variations in the thickness of the mat along the translational direction, a visual indication of the variations in the thickness of the mat along the lateral direction, or a combination thereof. Furthermore, in certain embodiments, the output signal may be indicative of instructions to control one or more components of the agricultural system (e.g., alone or in combination with the instructions to the user interface) to reduce the variations in the thickness of the mat along the translational direction and/or to reduce the variations in the thickness of the mat along the lateral direction.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A monitoring system for a conveying system of an agricultural harvester, comprising:
a controller comprising a memory and a processor, wherein the controller is configured to:
receive a sensor signal indicative of a thickness of a mat of agricultural product formed by a pair of opposing belts configured to compress the agricultural product and to transport the agricultural product from an accumulator of the agricultural harvester to a baler of the agricultural harvester;
determine a volume of the mat based on the thickness, identify variations in the thickness of the mat along a translational direction of the mat, identify variations in the thickness of the mat along a lateral direction crosswise to the translational direction, or a combination thereof; and
output an output signal based on the volume of the mat, the variations in the thickness of the mat along the translational direction, the variations in the thickness of the mat along the lateral direction, or the combination thereof.

2. The monitoring system of claim 1, comprising a sensor communicatively coupled to the controller, wherein the sensor is configured to output the sensor signal.

3. The monitoring system of claim 2, wherein the sensor comprises a non-contact sensor directed toward a surface of the mat downstream from an outlet of the pair of opposing belts.

4. The monitoring system of claim 2, wherein the sensor comprises a position sensor configured to monitor a position of a roller engaged with one belt of the pair of opposing belts.

5. The monitoring system of claim 4, wherein the roller is positioned at an outlet of the pair of opposing belts.

6. The monitoring system of claim 4, wherein the position sensor is configured to monitor an angle of the roller about an axis extending along the translational direction.

7. The monitoring system of claim 2, wherein the sensor comprises a position sensor configured to monitor a position of a roller positioned downstream from an outlet of the pair of opposing belts and configured to engage a surface of the mat.

8. The monitoring system of claim 1, wherein the output signal is indicative of instructions to control one or more components of the agricultural harvester to reduce the variations in the thickness of the mat along the translational direction, the variations in the thickness of the mat along the lateral direction, or a combination thereof.

9. The monitoring system of claim 8, wherein the output signal is indicative of instructions to control a speed of one belt of the pair of opposing belts relative to a speed of the other belt of the pair of opposing belts, to control a speed of an agitation roller positioned upstream of an inlet of the pair of opposing belts, or a combination thereof.

10. A conveying system for an agricultural harvester, comprising:
a pair of opposing belts configured to compress agricultural product and to transport the agricultural product from an accumulator of the agricultural harvester to a baler of the agricultural harvester; and
a monitoring system, comprising:
a sensor configured to output a sensor signal indicative of a thickness of a mat of the agricultural product formed by the pair of opposing belts; and
a controller comprising a memory and a processor, wherein the controller is communicatively coupled to the sensor, and the controller is configured to:
receive the sensor signal indicative of the thickness of the mat;
determine a volume of the mat based on the thickness, identify variations in the thickness of the mat along a translational direction of the mat, identify variations in the thickness of the mat along a lateral direction crosswise to the translational direction, or a combination thereof; and
output an output signal based on the volume of the mat, the variations in the thickness of the mat along the translational direction, the variations in the thickness of the mat along the lateral direction, or the combination thereof.

11. The conveying system of claim 10, wherein the output signal is indicative of instructions to control one or more components of the agricultural harvester to reduce the variations in the thickness of the mat along the translational direction, the variations in the thickness of the mat along the lateral direction, or a combination thereof.

12. The conveying system of claim 11, wherein the output signal is indicative of instructions to control a speed of one belt of the pair of opposing belts relative to a speed of the other belt of the pair of opposing belts, to control a speed of an agitation roller positioned upstream of an inlet of the pair of opposing belts, or a combination thereof.

13. The conveying system of claim 10, wherein the sensor comprises a non-contact sensor directed toward a surface of the mat downstream from an outlet of the pair of opposing belts.

14. The conveying system of claim 10, comprising a roller engaged with one belt of the pair of opposing belts, wherein the sensor comprises a position sensor configured to monitor a position of the roller.

15. A method for monitoring a mat of agricultural product, comprising:
receiving, via a controller comprising a memory and a processor, a sensor signal indicative of a thickness of the mat formed by a pair of opposing belts configured to compress the agricultural product and to transport the agricultural product from an accumulator of an agricultural harvester to a baler of the agricultural harvester;
determining, via the controller, a volume of the mat based on the thickness, identifying, via the controller, variations in the thickness of the mat along a translational direction of the mat, identifying, via the controller, variations in the thickness of the mat along a lateral direction crosswise to the translational direction, or a combination thereof; and
outputting, via the controller, an output signal based on the volume of the mat, the variations in the thickness of the mat along the translational direction, the variations in the thickness of the mat along the lateral direction, or the combination thereof.

16. The method of claim 15, wherein the output signal is indicative of instructions to control one or more components of the agricultural harvester to reduce the variations in the thickness of the mat along the translational direction, the variations in the thickness of the mat along the lateral direction, or a combination thereof.

17. The method of claim 16, wherein the output signal is indicative of instructions to control a speed of one belt of the pair of opposing belts relative to a speed of the other belt of the pair of opposing belts, to control a speed of an agitation roller positioned upstream of an inlet of the pair of opposing belts, or a combination thereof.

18. The method of claim 15, wherein receiving the sensor signal comprises receiving the sensor signal from a non-contact sensor directed toward a surface of the mat downstream from an outlet of the pair of opposing belts.

19. The method of claim 15, wherein receiving the sensor signal comprises receiving the sensor signal from a position sensor configured to monitor a position of a roller engaged with one belt of the pair of opposing belts.

20. The method of claim 15, wherein receiving the sensor signal comprises receiving the sensor signal from a position sensor configured to monitor a position of a roller positioned downstream from an outlet of the pair of opposing belts and configured to engage a surface of the mat.
